(19) United States
(12) Patent Application Publication
(10) Pub. No.: US 2007/0094472 A1
(43) Pub. Date: Apr. 26, 2007

(54) Method for persistent mapping of disk drive identifiers to server connection slots

(75) Inventors: Kevin Marks, Round Rock, TX (US); Jacob Cherian, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/254,635

(22) Filed: Oct. 20, 2005

(51) Int. Cl. G06F 12/00

(52) U.S. Cl. 711/170; 711/112

(57) ABSTRACT

A method for mapping disk drives of a data storage system to server connection slots. The method may be used when an SAS expander is used to add additional disk drives, and maintains the same drive numbering scheme as would exist if there were no expander. The method uses the IDENTIFY address frame of an SAS connection to determine whether a device is connected to each phy of a controller port, and whether the device is an expander or end device (disk drive).

### TECHNICAL FIELD OF THE INVENTION

This invention relates to data storage systems, and more particularly to data storage systems that use SAS expanders.

### BACKGROUND OF THE INVENTION

Many of today's computers are designed with a “backplane”, which is a circuit board containing sockets into which other circuit boards can be plugged in. For example in personal computers, the backplane is the large circuit board that contains sockets for expansion cards.

Server-type computers are frequently outfitted with a “hard drive backplane”. A number of “slots” each have a connector for a hard drive data storage device.

The backplane of a computer system only accepts a fixed number of devices. A popular interface for connecting devices to the backplane is known as SAS (Serial Attached Small Computer System Interface). SAS systems are point-to-point configurations that may use expanders to act as intermediary devices between initiator devices (such as hosts) and target devices (such as peripherals and typically storage devices). The expanders allow for systems in which one or more initiators may have a connection to one or more targets.

Like other of today's peripheral interfaces, the SAS interface is designed to permit “hot plugging”. This is the ability to add and remove devices to the computer while the computer is running, such that the operating system automatically recognizes the change.

### SUMMARY OF THE INVENTION

In accordance with teachings of the present disclosure, a system and method are described for a method for mapping disk drives of a data storage system to server connection slots. The method may be used when one or more SAS expanders is used to add additional disk drives, and maintains the same drive numbering scheme as would exist if there were no expanders. The method uses the IDENTIFY address frame data of a SAS link to determine whether a device is connected to each phy of a controller port, and whether the device is an expander or end device (disk drive).

The method assigns a Device ID to each disk drive in the system. This Device ID may be used for disk management functions, such as controlling the LEDs on the hard disk backplane.

The method is “persistent” in the sense that the Device IDs for the drive slots are the same regardless of whether or not the data storage subsystem of the server has expanders or not.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates relevant portions of a server system 100 having a SAS-configured data storage, including a 6-port SAS expander.

FIG. 2 illustrates how the disk drives are mapped to drive slots in a system such as the system of FIG. 1 but without the expander.

FIG. 3 illustrates how the disk drives are mapped to drive slots in the system of FIG. 1.

FIG. 4 illustrates relevant portions of a server system 400 having a SAS-configured data storage, including a 12-port SAS expander.

FIG. 5 illustrates how the disk drives are mapped to drive slots in a system such as the system of FIG. 4 but without the expander.

FIG. 6 illustrates how the disk drives are mapped to drive slots in the system of FIG. 4.

### DETAILED DESCRIPTION OF THE INVENTION

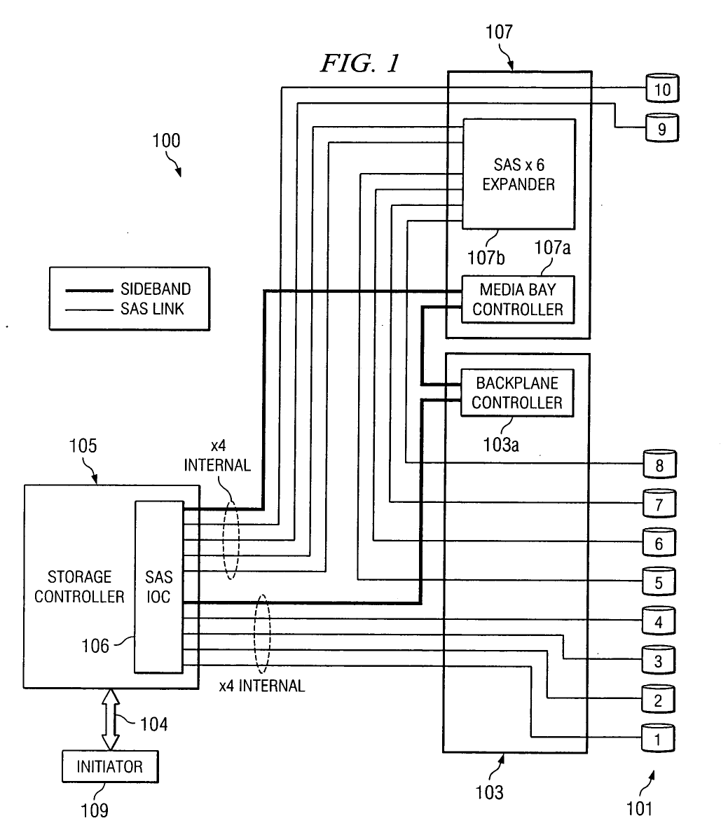

FIG. 1 illustrates relevant portions of a server system 100 having a SAS-configured data storage. For purposes of this description, system 100 may be any “information handling system” having SAS-configured data storage. An “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In FIG. 1, other than the data storage system, only the most basic elements of system 100 are explicitly illustrated. It has a processing system 109, having at least active memory, a processor, and a bus for internal and I/O communications. In accordance with SAS terminology, processing system 109 is referred to herein as an “initiator”, and is typically a data storage server.

In the example of FIG. 1, system 100 has ten disk drives 101. Drives 101 are in data communications with the rest of system 100 via a storage controller 105. In the example of this description, controller 105 is a RAID controller, which permits the server 100 to see only the controller 101, which deals with the drives directly. A RAID (Redundant Array of Inexpensive Disks) consists of two or more disks working in parallel. The disks appear as one drive to the user, and offer enhanced performance or security (or both). The software to perform the RAID-functionality and control the hard disks is located on controller 105.

Controller 105 contains a SAS I/O controller (IOC) 106, which controls input and output to and from the disk drives in accordance with the SAS standard. Controller 105 communicates with the rest of system 100 via a bus 104, for example a PCI type bus.

Eight of the disk drives 101 are connected to a backplane 103. Backplane 103 has an associated backplane controller 103a.

System 100 also has at least one media bay backplane 107. Media bay backplane 107 is designed to permit installation of additional peripheral devices. As compared to the internal slots of backplane 103, a device installation in media bay backplane 107 is referred to as being “exposed” or “accessible”. Media bay backplane 107 has an associated controller 107a.

In the example of FIG. 1, the media bay backplane 107 also includes an expander 107b. In SAS terminology, an “expander” is a device that provides an initiator with access to additional targets (and vice versa). Expanders provide functionality similar to that provided by a hub or switch. Expanders can be connected to other expanders, SATA target devices, SAS target devices or SAS initiators. Expanders connect initiators to targets, constituting a SAS domain.

In system 100, expander 107b is used to increase the number of drives that can be connected to controller 105. Expander 107b conforms to SAS standard, which as discussed in the background, is an interface standard which defines how expander 107b will interface with initiator and target devices.

In the example of FIG. 1, expander 107b is a six port |(x6) |expander. It is an “edge expander.”

As stated above, drive controller 105 contains an SAS controller 106, which is connected to both backplane controller 103a and media bay controller 107a via sideband signals.

SAS controller 105 is directly connected to Drives 1-4 on backplane 103 via a first port. SAS controller 105 is directly connected to Drives 9 and 10 and to expander 107b via a second port. Expander 107b is then connected to Drives 5-8. This configuration is for illustration; the concepts described herein may be extended to include multiple backplanes, and different topologies and drive counts.

One function of data storage controller 105 is to control the status LEDs associated with the drive slots on backplane 103. For this purpose, RAID software of controller 105 uses SES or SAF-TE commands delivered to the backplane controller 103a. This requires that the controller 105 have some means for mapping its ports (and the drives connected to them) to the slots of backplane 103.

In servers with hot-plug backplanes, but lacking SAS expander 107b, hard drives complying with the parallel SCSI standard are simple to correlate to the respective drive slot in which they reside. This is because conventional parallel SCSI backplanes are designed so that, depending on the slot into which the drive is inserted, the SCSI Target ID is set to the same Drive ID as the slot number of the backplane. This is accomplished by jumping or grounding signals on the backplane connector for each slot.

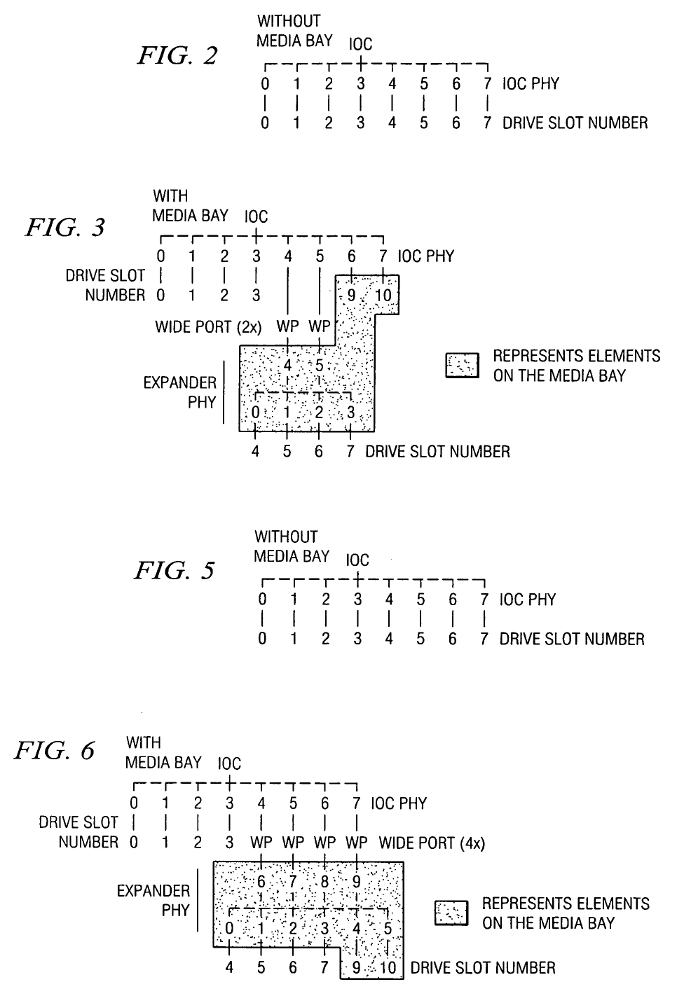

FIG. 2 illustrates how I/O controller ports are mapped to drive slots in a system such as system 100 but lacking an expander. In FIG. 2, each port of controller 105 is associated with a single “phy”. This is in contrast to the system described below in connection with FIG. 3, where a controller port may be a “wide port” that uses more than one phy to establish a wide link.

In FIG. 2, each phy connects directly to each drive 101 through backplane 103. The correlation between drives and their slots permits easy control of each drive slot's status LEDs by the controller. Port 0 connects to Slot |1,| etc. The controller updates the status of the drive based on the assigned Device ID, which also corresponds to the proper drive slot number.

Thus, referring to both FIGS. 1 and 2, in the absence of expander 107b, a logical method of mapping server slots to the drives that reside in them is to use the port (phy) number of the controller 106 to which the drive is connected. This permits the controller 106 to control the status LEDs for the slots based on the port (phy) number.

In the configuration of FIG. 1, however, which does have an expander 107b, the above-described correlation method does not work. This is because all SAS devices (including expander 107b) have an address, in the form of a 64-bit worldwide name (WWN), which is set when the device is manufactured. This SAS address is used during communications with the expander and end devices.

FIG. 3 illustrates a method for defining how, for the system of FIG. 1, storage controller 105 discovers disk drives and assigns Device IDs. The shaded portions of FIG. 3 represent drives connected via media bay backplane 107 and expander 107b. The Device ID is a number assigned to a drive 101, which is used for communicating with the drive and for correlating the drive to a server slot.

The system layout is configured so that the lowest numbered slot on any device is connected to the lowest numbered Phy for that device. Device IDs are assigned in the order of discovery.

The layout of Phy to slot is correct regardless of whether server 100 has any expanders. When a drive is not present on a Phy, the Device ID is reserved. Thus, if a drive is later inserted, the ordering is preserved.

For discovering drives 101, controller 105 traverses its ports, beginning with the port containing Phy 0. The discovery process traverses all devices on Phy 0 before moving to the next port, and so on. When a Phy is not part of a wide port, the port and Phy are the same. When multiple Phys are part of a wide port, discovery is performed across the plurality of Phys.

In the example of FIG. 3, starting with Device ID 0 for drives that are on backplane 103, the corresponding Device ID is associated with the slot number. When a drive is not present on a Phy (of either the I/O controller or an expander) attached to a server slot, the Device ID number is skipped. Thus, if nothing is attached to Phy 3, which corresponds to Slot 4, the Device ID is skipped. Then, if a device is present in Slot 4, it will have Device ID 3. In this manner, drives 1-4 are assigned Device ID's 0-3.

When an expander is connected to a Phy (or Phys in the case of a wide port), controller 105 discovers the drives in order (from Phy 0 to Phy x) on the expander, and assigns Device IDs in the same manner, reserving Device IDs for Phys that are connected to empty slots and assigning Device IDs for drives that are present.

In the configuration of FIG. 1 and as shown in FIG. 3, phys 4 and 5 of controller 105 are configured as a 2× wide ports. They expand to slots 5-8 on backplane 103, and hence the drives in those slots have those Device IDs. Phys 6 and 7 are connected to Drives 9 and 10 on the backplane and those Drives are given corresponding Device IDs.

The above-described method can be restated in SAS equivalent terms. In an SAS system, an identification sequence is key to all device-to-device communications. During the identification sequence, SAS devices on an operational link exchange IDENTIFY address frames. An IDENTIFY address frame contains information about the connected SAS device, such as its SAS address, whether it supports certain protocols (SMP, STP, SSP), whether it is a target or initiator or both, and the Device Type. A Device Type can be an expander or an end device type. The information in the IDENTIFY address frame is used by a SAS initiator when it discovers what devices are present in the SAS domain, whether they are target or initiator devices, and the protocols they support. This information is returned to the SAS initiator, using the SMP DISCOVER command following the SAS discovery algorithm. Via SMP commands, initiators are able to find out information about the expander, such as the number of phys in the expander, the type of device connected to a particular expander phys, information about the expander manufacturer, etc.

To map its ports to drive slots, controller 105 uses the IDENTIFY address frame data as follows. Starting at Phy 0, it reads the Attached Device Type (ADT) from the IDENTIFY address frame data if received. If no IDENTIDY address frame is received, i.e. no device is present, internally the ADT is set to “no device”, then it reserves Device ID 0. If the ADT is set to “end device”, it assigns a Device ID 0 to the drive connected to Phy 0 which corresponds to slot 1.

If ADT is set to “edge expander device” or “fanout expander device”, controller 105 discovers all devices attached to the expander by assigning each Phy with a device present to the next Device ID and reserving the next Device ID if no drive is present. Once all devices on the expander are discovered, the controller 105 continues with its own next Phy port.

When discovery is complete, controller 105 will have a sparsely populated list of Device IDs. RAID controller 106 can now use these Device IDs to operate the slot LEDs.

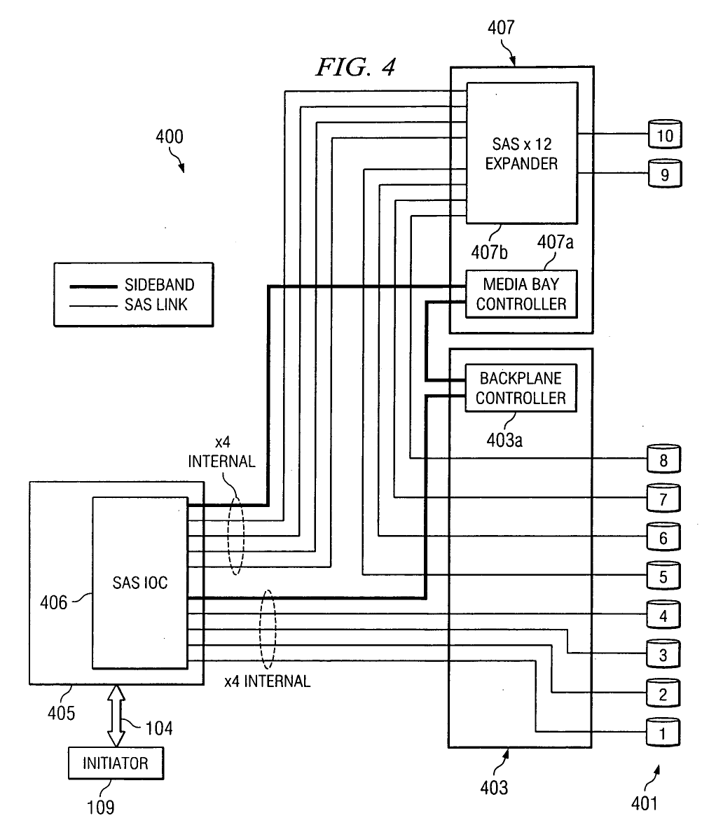

FIGS. 4-6 illustrate the same concept as described above. In FIG. 4, like system 100, system 400 is an SAS configured storage system. Devices of system 400 that correspond to like devices in system 100 are similarly numbered. However, in system 400, expander 407b has 12 ports. FIG. 5 illustrates disk drive mapping in the absence of the expander. In FIG. 6, four controller ports are configured as a 4× wide port that expand to drive slots 5-10, and hence the drives in those slots are assigned the corresponding Device IDs minus one.

What is claimed is:

1. A method of mapping ports of a SAS controller to disk drives in a data storage system, the data storage system having at least one expander for connecting to one or more disk drives, and the controller having ports for x number of connections (Phys 0-x), comprising:
receiving an SAS IDENTIFY address frame on each phy of the controller;
beginning with the port of the controller containing Phy 0;
if the IDENTIFY address frame indicates that the device associated with that port is an end device, assigning Device ID 0 to that device;
if the IDENTIFY frame indicates that the device associated with that port is an expander, assigning Device ID 0-x to each next Drive 1-x that has a Phy to that expander;
if no IDENTIFY address frame is received, indicates that no device is associated with that port, reserving a Device ID for Phy 0; and
repeating the above steps for Phy 1-x of the controller, assigning each next successive Device ID in order of discovery of an associated disk drive.

2. The method of claim 1, further comprising controlling status LEDs associated with the disk drives, based on the Device IDs.

3. The method of claim 2, wherein a RAID type drive controller receives the Device IDs from the controller and controls the status LEDs.

4. The method of claim 1, wherein the lowest numbered drive slot of any device in the system is connected to the lowest numbered Phy for that device.

5. The method of claim 1, further comprising inserting a disk drive into an empty drive slot, and assigning a reserved Device ID to that disk drive.

6. The method of claim 1, wherein the controller receives data from the Device Type field of the IDENTIFY address frame.

7. The method of claim 1, wherein the controller receives the IDENTIFY address frame data in response to an SMP command for phys contained in an expander.

8. The method of claim 1, wherein the SMP command is a DISCOVER command.
